(19) United States
(12) Patent Application Publication
(10) Pub. No.: US 2012/0230622 A1
(43) Pub. Date: Sep. 13, 2012

(54) ROLLING BEARING

(75) Inventors: Toshikazu Yabe, Kanagawa (JP); Yoshio Shoda, Kanagawa (JP)

(73) Assignee: NSK LTD., Tokyo (JP)

(21) Appl. No.: 13/512,551

(22) PCT Filed: Mar. 28, 2011
(86) PCT No.: PCT/JP2011/057711

§ 371 Date: May 29, 2012

(30) Foreign Application Priority Data
Apr. 26, 2010 (JP) 2010-100906

(51) Int. Cl. F16C 32/00; F16C 33/76

(52) U.S. Cl. 384/448

(57) ABSTRACT

A rolling bearing includes: fitting grooves of a rotating ring for mounting seal devices formed on both end surfaces of the rotating ring into same shapes; and seal grooves of a stationary ring formed on both end surfaces of the stationary ring into shapes symmetrical about a rolling element, wherein: each of the pair of seal devices is configured by connecting a fitting portion made of an elastic material to be fit to the seal fitting groove to an end portion of each core metal, and a seal lip portion made of an elastic material to be brought into sliding contact with the seal groove to the other end portion; the pair of seal devices are formed into shapes symmetrical about the rolling element; and a magnet portion facing a magnetic sensor of a magnetic encoder is bonded to one of the core metals.

### TECHNICAL FIELD

The present invention relates to a rolling bearing having a magnetic encoder function for use in detecting the number of revolutions of a rotating member. More particularly, the present invention relates to a rolling bearing for use in a washing machine, a motorcycle, or the like.

### BACKGROUND ART

Hitherto, there has been a single row deep groove ball bearing invented by the present applicant as that provided with a multipolar magnet to add, to a seal existing on an end surface portion, a magnetic encoder function aimed at detecting the number of revolutions (see Patent Document 1).

As illustrated in FIG. 3, a rolling bearing 10 disclosed in the Patent Document 1 has an outer ring 11 serving as a rotating ring, an inner ring 12 serving as a stationary ring, plural balls 13 respectively serving as rolling elements circumferentially rotatably provided in an annular space defined by the outer ring 11 and the inner ring 12, a retainer 21 on which pockets 22 respectively retaining the balls 13 are formed at predetermined intervals in a circumferential direction, a pair of seal devices 16 and 23 arranged at an opening end portion of the annular space and at an axial end portion of the outer ring 11 (FIG. 3 illustrates only one axial end portion thereof), a magnet portion 25 which is attached to one 23 of the seal devices and functions as a magnetic encoder, and a magnetic sensor 29 provided to be closely opposed to the magnet portion 25. The annular space is filled with a lubricating agent such as grease.

The seal device 23 (hereinafter sometimes referred to also as the magnet-portion-side seal device), to which the magnet portion 25 is bonded, includes a cross-sectionally L-shaped annular core metal 15, and a seal lip portion 24 which is formed on an inside-diameter-side peripheral edge portion of the core metal 15 and brought into sliding contact with a seal groove 20 provided at the outer peripheral end of the inner ring 12. The other end of the magnet-portion-side seal device 23 is fit onto a step-like fitting groove 17 provided on the outer peripheral surface of the axial end portion of the outer ring 11. The other seal device 16 configures a contact seal having a seal lip portion 19 put into sliding contact with the seal groove 20.

The magnet portion 25 is attached to the axial outer end portion (bonding-surface) 28 of the core metal 15. The magnet portion 25 is a multipolar magnet configured such that an N-pole-magnetized portion magnetized with N-pole and an S-pole-magnetized portion magnetized with S-pole are arranged alternately and circumferentially on a detected surface 27 formed to have a step with respect to an axially outer end surface 26. The magnet portion 25 is arranged to be located axially inwardly from an axial end surface 11a of the outer ring 11.

### RELATED ART REFERENCE

### Patent Document

Patent Document 1: JP-A-2007-321894.

### SUMMARY OF THE INVENTION

### Problems to be Solved by the Invention

However, the rolling bearing described in Patent Document 1 is such that the magnet-portion-side seal device 23 differs from the other seal device 16 in the shapes of the core metal and a fitting portion, and that thus both the end surfaces of the outer ring 11 differ from each other in shape. Accordingly, the processing of both the end surfaces of the outer ring 11 includes two stages. Thus, the magnet-portion-side seal device 23 and the seal devices of other seal-equipped rolling bearings cannot be commonized. This leads to cost increase.

The magnet-portion-side seal device 23 is such that a part fixed to a fitting portion 17 of the outer ring 11 is not covered with rubber. Thus, if the rotating member rotates at an excessively high speed, there is a risk of leakage of grease from such a part.

The invention is accomplished by focusing attention to such problems. The invention aims at reducing cost by configuring fitting grooves on both end surfaces of rolling bearings capable of detecting the number of revolutions of a rotating member, and seal grooves as common components for the rolling bearings according to the invention and conventional seal-equipped rolling bearings, and at preventing the leakage of grease from a magnet-portion-side seal device.

### Means for Solving the Problems

To achieve the above objects, the invention provides the following rolling bearings.

(1) A rolling bearing having a stationary ring, a rotating ring, plural rolling elements provided circumferentially rotatably in an annular space defined by the stationary ring and the rotating ring, a retainer configured to retain the rolling elements rotatably, and a pair of seal devices configured to seal an opening end portion of the annular space. The rolling bearing wherein:

fitting grooves of the rotating ring for mounting the seal devices are respectively formed on both end surfaces of the rotating ring into shapes symmetrical about the rolling element, that seal grooves of the stationary ring are respectively formed on both end surfaces of the stationary ring into shapes symmetrical about the Tolling element; and

each of the pair of seal devices is configured by connecting a fitting portion made of an elastic material to be fit to the fitting groove to an end portion of each core metal, and by connecting a seal lip portion made of an elastic material to be brought into sliding contact with the seal groove to the other end portion of the one of the core metals, the pair of seal devices are respectively formed into shapes symmetrical about the rolling element, and a magnet portion facing a magnetic sensor of a magnetic encoder is bonded to one of the core metals, while the other core metal is covered with the elastic material.

(2) The rolling bearing described in the above (1), characterized in that the magnet portion protrudes from an axial end surface of each of the stationary ring and the rotating ring.

(3) The rolling bearing described in the above (1) or (2), wherein the magnet portion includes magnetic powder and a thermoplastic resin.

(4) The rolling bearing described in the above (3), wherein the thermoplastic resin is at least one resin selected from the group consisting of polyamide 6, polyamide 66, polyamide 12, polyamide 612, polyamide 610, polyamide 11, polyphenylene sulfide (PPS), modified polyamide 6T, polyamide 9T, modified polyamide 12 that has a molecular structure including a soft segment, a modified polyester resin that has a molecular structure including a soft segment, and a modified polystyrene resin that has a molecular structure including a soft segment.

(5) The rolling bearing described in the above (1) or (2), wherein the magnet portion includes magnetic material powder and rubber.

(6) The rolling bearing described in the above (5), wherein the rubber is at least one type of rubber selected from the group consisting of nitrile rubber, acrylic rubber, fluororubber, and silicon rubber.

(7) The rolling bearing described in one of the above (1) to (6), wherein the magnet portion is bonded thereto by insert-molding using, as a core, the core metal coated with a semicured adhesive, and that the adhesive is a phenolic resin-based adhesive or an epoxy resin-based adhesive, whose curing reaction proceeds in two stages.

(8) The rolling bearing described in one of the above (1) to (6), wherein the magnet portion is bonded to the core metal with an adhesive, and the adhesive is at least one type of an adhesive selected from the group consisting of one-component epoxy resin-based adhesive, a two-component epoxy resin-based adhesive, and an ultraviolet (UV) cured acrylic adhesive.

### Advantage of the Invention

The rolling bearing according to the invention is such that the inner and outer rings and the seal devices can be commonized with those of the conventional seal-equipped rolling bearings. Thus, cost reduction can be performed. In addition, the fitting portion of the magnet-portion-side seal device is made of an elastic material and can be fit to the fitting groove without space. Consequently, the leakage of grease can be prevented.

An end surface of the magnet portion can be protruded from an end surface of the bearing. Thus, a magnet thickness is increased, with the result of increase of a magnetic flux density per pole. Accordingly, rotation accuracy can be enhanced. Incidentally, the end surface of the magnet portion can be placed within the end surface of the bearing. This results in little interference thereof with a magnetic sensor. In addition, mountability thereof is enhanced. The entire bearing can be miniaturized.

### BRIEF DESCRIPTION OF THE DRAWINGS

FIG. 1 is a cross-sectional view illustrating an example of a rolling bearing according to the invention.

FIG. 2 is a cross-sectional view illustrating another example of the rolling bearing according to the invention.

FIG. 3 is a cross-sectional view illustrating an example of a conventional rolling bearing having a magnetic encoder function.

### MODES FOR CARRYING OUT THE INVENTION

Hereinafter, the invention is described in detail with reference to the drawings,

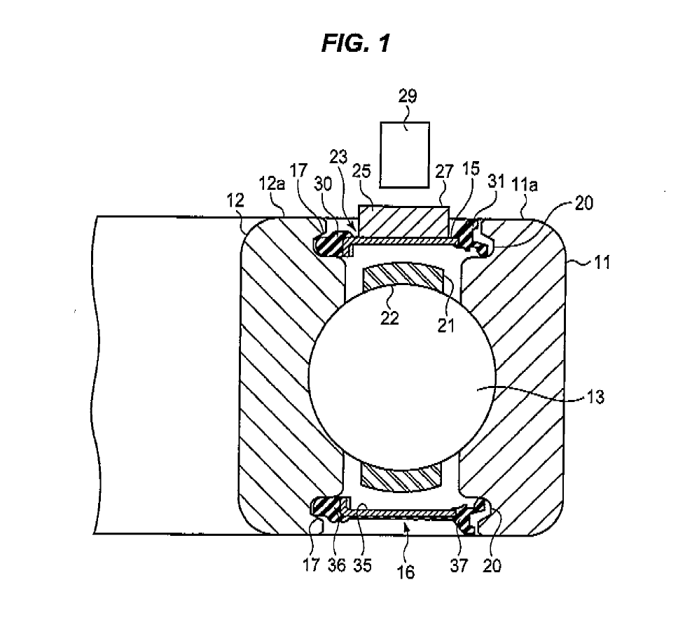

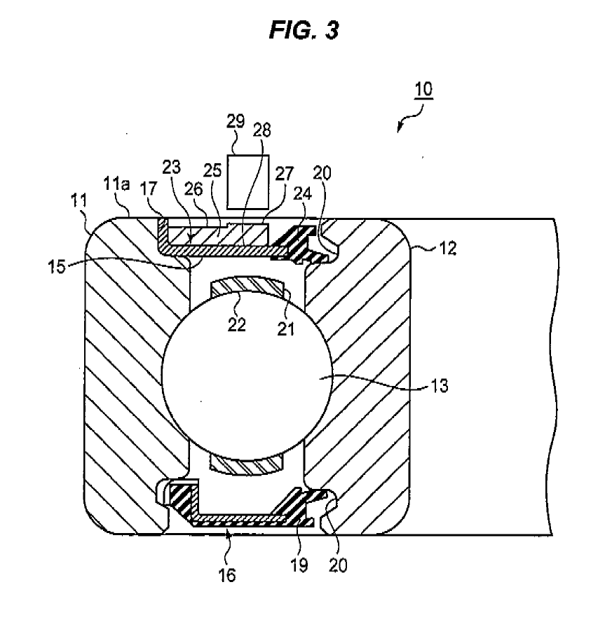

FIG. 1 is a cross-sectional view illustrating an example of a rolling bearing according to the invention, similarly to FIG. 3. A rolling bearing 10 includes an outer ring 11 serving as a stationary ring, an inner ring 12 serving as a rotating ring, plural balls 13 respectively serving as rolling elements circumferentially rotatably provided in an annular space defined by the outer ring 11 and the inner ring 12, a retainer 21 on which pockets 22 respectively retaining the balls 13 are formed at predetermined intervals in a circumferential direction, a pair of seal devices 16 and 23 arranged at an opening end portion of the annular space and at axial end portions of the outer ring 11, a magnet portion 25 which is magnetized multipolarly and circumferentially and attached to the magnet-portion-side seal device 23 and functions as a magnetic encoder, and a magnetic sensor 29 provided to be closely opposed to the magnet portion 25. The annular space is filled with a lubricating agent such as grease.

According to the invention, fitting grooves 17 of the inner ring 12 are respectively formed on both end surfaces of the inner ring 12 into shapes symmetrical about the ball 13. Seal grooves 20 of the outer ring 11 are respectively formed on both end surfaces of the outer ring 11 into shapes symmetrical about the ball 13, This eliminates necessity for processing the grooves of the outer ring 11, which respectively correspond to the magnet-portion-side seal device 23 and the other seal device 16, into different shapes, similarly to the rolling bearing 10 illustrated in FIG. 3.

In addition, in the magnet-portion-side seal device 23, a fitting portion 30 made of an elastic material and formed into a shape to be fit to the fitting groove 17 of the inner ring 12 is bonded to a fitting-groove-side end portion of the core metal 15. A seal lip portion 31 made of an elastic material to be brought into sliding contact with the seal groove 20 of the outer ring 11 is bonded to the seal-groove-side end portion of the core metal 15. A magnet portion 27 is bonded to the outer side of the core metal 15. In such a magnet-portion-side seal device 23, the fitting portion 30 made of the elastic material is fit into the fitting groove 17 of the inner ring 12 without space. Accordingly, occurrence of grease leakage is prevented.

A core metal 35 having a shape symmetric to the shape of the core metal 15 of the magnet-portion-side seal device 23 about the ball 13 is used in the other seal device 16. A fitting portion 36 having a shape symmetric to the shape of the fitting groove 17 of the magnet-portion-side seal device 23 about the ball 13 is formed at the fitting-groove-side end portion of the seal device 16, while a seal lip portion 37 having a shape symmetric to the shape of the seal lip portion 31 of the magnet-portion-side seal device 23 about the ball 13 is formed at the seal-groove-side end portion of the seal device 16. In addition, the outer side of the core metal 35 is covered with the same elastic material.

A configuration in which the shapes of each of a pair of the fitting grooves 17 of the inner ring 12, a pair of the seal grooves 20 of the outer ring 11, and a pair of the magnet-portion-side seal device 23 and the other seal device 16 are symmetric about the ball 13, as described above, is similar to those of general seal-equipped rolling bearings. Thus, an existing seal-equipped rolling bearing can be used as it is.

In addition, the magnetic flux density is increased by forming the magnet portion 25 to be thick such that a detected surface 27 protrudes more outwardly than an end surface 11a of the outer ring 11 and an end surface 12a of the inner ring 12, as illustrated in the drawing. Thus, the accuracy of detection by a magnetic sensor 29 is enhanced.

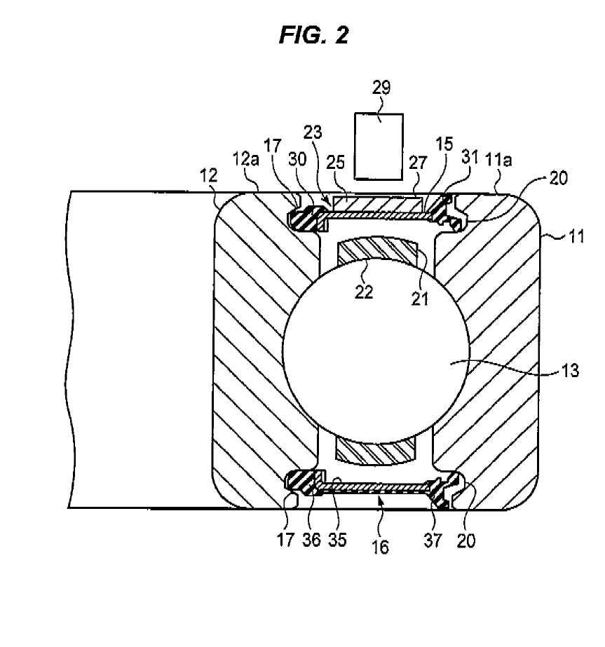

Alternatively, if the magnet portion 25 is formed such that the detected surface 27 is provided more inwardly than the end surface 11a of the outer ring 11 and the end surface 12a of the inner ring 12, the number of revolutions can be detected by the magnetic sensor 29 as shown in FIG. 2. There is little interference between the magnet portion 25 and the magnetic sensor 29. Mountability is enhanced. In addition, the entire bearing can be miniaturized.

Although a magnet material forming the magnet portion 25 is not limited to a specific material, a magnet compound containing 70 to 92 wt % of magnetic powder and using a thermoplastic resin or rubber as a binder can preferably be used as the magnet material, in view of the bonding ability of the magnet portion 25 to the core metal 15. Ferrite magnetic-powder such as strontium ferrite magnetic-powder and barium ferrite magnetic-powder, and rare-earth magnetic-powder such as neodymium-iron-boron magnetic-powder, samarium-cobalt magnetic-powder, and samarium-iron magnetic-powder can be used as the magnetic powder. Alternatively, magnetic-powder mixed with rare-earth element such as lanthanum to improve the magnetic characteristic of ferrite can be used as the magnetic powder. If the content of magnetic powder is less than 70 wt %, the magnetic characteristic thereof is deteriorated. In addition, it is difficult to multipolarly and circumferentially magnetize the magnet portion 25 at fine pitches. This is unfavorable. In contrast, if the content of magnetic powder exceeds 92 wt %, the amount of binder is too small. Thus, the strength of the entire magnet is low. In addition, it is difficult to form the magnet. Accordingly, practicality is lowered. If a thermoplastic resin is used as a binder, injection-moldable thermoplastic resins are preferable. More specifically, polyamide 6, polyamide 66, polyamide 12, polyamide 612, polyamide 610, polyamide 11, polyphenylene sulfide (PPS), modified polyamide 6T, polyamide 9T, modified polyamide 12 that has a molecular structure including a soft segment, a modified polyester resin that has a molecular structure including a soft segment, a modified polystyrene resin that has a molecular structure including a soft segment, and the like can be used as the thermoplastic resin. If calcium chloride used as a snow-melting agent can be applied to the magnet portion, together with water, or humidity is assumed to be high, it is more preferable to use, as a resin binder, a resin whose water absorbability is low, such as a resin having a that polyamide 12, polyamide 612, polyamide 610, polyamide 11, polyphenylene sulfide (PPS), modified polyamide 6T, polyamide 9T, modified polyamide 12 that has a molecular structure including a soft segment, a modified polyester resin that has a molecular structure including a soft segment, and a modified polystyrene resin that has a molecular structure including a soft segment.

In addition, the following substance that enhances the bending deflection and the resistance to cracking of a material by being added thereto is most suitable for a binder that prevents a crack from being generated due to abrupt temperature change (thermal shock) assumed to occur in the usage environment of the rolling bearing. That is, such a substances is modified-polyamide 12, modified polyester, modified polystyrene, a mixture of modified-polyamide 12 and polyamide 12, a mixture of a modified polyester resin and a polyester resin, or a mixture of modified-polystyrene and polystyrene. Incidentally, a combination of a resin that doesn't include the above soft segment, and one of other shock-resistance-improving materials, such as modified polyamide 12, performing similar functions can be used as a thermal-shock-resistant binder.

Various types of vulcanized rubber ultrafine particles can be used as the other shock-resistance-improving materials. More specifically, such vulcanized rubber ultrafine particles are fine particles that have an average particle diameter being within a range from 30 nm to 300 nm and are of at least one type selected from the group consisting of styrene-butadiene rubber, acrylic rubber, acrylonitrile-butadiene rubber, carboxyl-modified acrylonitrile-butadiene rubber, silicon rubber, chloroprene rubber, hydrogenated nitrile rubber, carboxyl-modified hydrogenated nitrile rubber, and carboxyl-modified styrene-butadiene rubber. If the vulcanized rubber ultrafine particles are less than 30 nm in average particle diameter, manufacturing costs are costly. In addition, the vulcanized rubber ultrafine particles are too fine. Thus, the vulcanized rubber ultrafine particles are deteriorative. This is undesirable. If the vulcanized rubber ultrafine particles exceed 300 nm in average particle diameter, dispersiveness is low. In addition, it is difficult to uniformly enhance the thermal-shock-resistance. This is undesirable. Among the above vulcanized rubber ultrafine particles, the following substances are preferable, in view of deterioration at the manufacture of pellets and at the actual formation of the magnet portion. That is, the preferable substances are acrylonitrile-butadiene rubber (nitrile rubber), carboxyl-modified acrylonitrile-butadiene rubber, acrylic rubber, silicon rubber, hydrogenated nitrile rubber, and carboxyl-modified hydrogenated nitrile rubber. In addition, among the preferable substances, the substances each having a molecular structure that includes an organic functional group such as a carboxyl group and an ester group interacts relatively strongly with a resin binder. Thus, such substances are more preferable. More specifically, such substances are carboxyl-modified acrylonitrile-butadiene rubber, acrylic rubber, and carboxyl-modified hydrogenated nitrile rubber. The vulcanized rubber ultrafine particles of such substances can be configured to contain a diphenylamine-based anti-aging agent such as 4,4′-(α, α-dimethylbenzyl)diphenylamine and a secondary anti-aging agent, such as 2-mercaptobenzimidazole, so as to be prevented from deteriorated due to heat and to oxygen.

In addition, ethylene-propylene unconjugated diene rubber (EPDM), maleic anhydride-modified ethylene-propylene unconjugated diene rubber (EPDM), an ethylene/acrylate copolymer, an ethylene/acrylate ionomer, and the like can be used as compounds to be immixed as the shock-resistance-improving material. Such compounds are shaped like pellets. When the compounds are mixed with magnetic power, a thermoplastic resin or the like and pelletized by an extruder, the compounds are fluidized and micro-dispersed in the binder.

An additive amount of the shock-resistance-improving material formed of the above modified resin or the vulcanized rubber ultrafine particles is preferably 5 wt % to 60 wt %, more preferably 10 wt % to 40 wt % in a total amount of the binder obtained by combining the shock-resistance--improving material with the thermoplastic resin. If the additive amount of the shock-resistance-improving material is less than 5 wt %, the amount of the shock-resistance-improving material is too small. Thus, the shock-resistance-improving material is poorly effective in improving the shock resistance. If the additive amount of the shock-resistance-improving material exceeds 60 wt %, the shock resistance is improved. However, the amount of the resin component is small. This results in reduction of the tensile strength and the like. Accordingly, practicality is lowered.

If an amine-based antioxidant having high antioxidizing ability is added to the material in addition to substances originally added thereto in order to prevent the thermoplastic resin and the shock-resistance-improving material (the modified resin, the vulcanized rubber ultrafine particles and the like) from being deteriorated due to heat, the deterioration thereof due to heat can be prevented. This is more preferable. Diphenylamine-based compounds such as 4,4′-(α,α-dimethyl-benzyl)diphenylamine and 4,4′-dioctyl-diphenylamine, and p-phenylenediamine-based compounds such as N,N′-diphenyl-p-phenylenediamine, N-isopropyl-N′-phenyl-p-phenylenediamine, N,N′-di-2-naphthyl-p-phenylenediamine, N,N′-bis(1-methylheptyl)-p-phenylenediamine, N,N′-bis(1,4-dimethylpentyl)-p-phenylenediamine, and N-(1,3-dimethylbutyl)-N′-phenyl-p-phenylenediamine are preferable. The additive amount of amine-based antioxidant is about 0.5 wt % to about 2.0 wt %, based on a total weight obtained by adding the weight of the binder including the thermoplastic resin and the shock-resistance-improving material and that of the antioxidant. If the additive amount of the amine-based antioxidant is less than 0.5 wt %, an antioxidation improving effect is insufficient. This is undesirable. If the additive amount of the antioxidant exceeds 2.0 wt %, antioxidation effect is not much enhanced. In addition, the amount of the magnetic powder and that of the binder are reduced for that. This leads to degradation of the magnetic characteristic and the mechanical strength, and is unfavorable. In addition, sometimes, a bloom is caused on a surface of a molding product. This can be supposed to affect the bonding of the magnet portion to the seal device, and is undesirable. If only an ordinary thermoplastic resin having no soft segment was used as the binder, a bending deflection amount at 23° C. (t=3.0 mm, an interspan distance was 50 mm according to ASTM D790) ranged from 1 mm to 2 mm. On the other hand, if the shock resistance improving material was contained in the binder, the bending deflection amount at 23° C. (t=3.0 mm, the interspan distance was 50 mm according to ASTM D790) fell into a range from 2 mm to 15 mm. Thus, the magnet portion excels in flexibility and is high in resistance to cracking. Accordingly, even if the bearing is used in severe environment in which the temperature change between high temperature and low temperature is repeated, breakage such as a crack is hardly to occur in the magnet portion.

If rubber is used as the binder, the following types of rubber having both of oil-resistance and heat-resistance are preferable. That is, the preferable types of rubber are nitrile rubber, acrylic rubber, hydrogenated nitrile rubber, fluororubber, silicon rubber, and the like.

Ferrite-based magnetic powder is most suitable in view of cost and resistance-to-oxidation. However, if rare-earth--based magnetic powder is used by giving priority to the magnetic characteristic, the rare-earth-based magnetic powder is low in resistance to oxidation. Thus, a surface-treated layer can be provided on the exposed surface of the magnet to maintain a stable magnetic characteristic over a long term. An electric-nickel-plated or electroless-nickel-plated layer, an epoxy-resin-coated film, a silicon-resin-coated film, a fluorine-resin-coated film, and the like can practically be used as the surface-treated layer.

The magnetic powder is adapted to a target magnetic characteristic, the usage environment, and the cost. If the magnetic characteristic is such that BHmax is about 1.4 MGOe to about 2.2 MGOe, ferrite-based magnetic powder such as strontium ferrite magnetic powder sufficiently meets the target magnetic characteristic. However, a BHmax's higher range of 1.6 MGOe to 2.2 MGOe for enhancing the accuracy of detecting the number of revolutions is difficult to achieve in the case of compounding ferrites with rubber-based binder, so that the orientation at magnetic field molding is low. Thus, the ferrites are compounded with binder using a thermoplastic resin as a main component, so that magnetic field injection molding is needed. If the BHmax is set to range from about 2.2 MGOe to about 5 MGOe in order to increase the precision of detecting the number of revolutions, the hybridization of ferrite-based magnetic powder, such as strontium ferrite magnetic powder, and rare-earth-based magnetic powder, is performed. Alternatively, only rare-earth-based magnetic powder is compounded with binder.

Magnetic materials, such as an electrogalvanized steel plate (e.g., SECC-P on the topmost layer of which phosphating is performed) which has corrosion-resistance above a certain level without deteriorating the magnetic characteristic of the above magnet material, are suitable for the material of the core metal 15. The electrogalvanized steel plate whose topmost layer is subjected to phosphating has a surface on which irregularity due to phosphate is present. Thus, the electrogalvanized steel plate is suitable for being bonded to the magnet portion using adhesive or the like. Further, if corrosion-resistance is needed, it is possible to use a magnetic stainless and the like such as a ferrite-based stainless steel (SUS430 and the like), and a martensite-based stainless steel (SUS410 and the like). If higher corrosion-resistance is needed, a high-corrosion-resistance ferrite-based stainless steel, such as SUS434 and SUS444, whose corrosion-resistance is enhanced by adding Mo or the like thereto are preferable. If a seal device body is made of a magnetic stainless steel, it is preferable to provide, when the seal device body is bonded to the magnet portion with adhesive, fine irregularity at least on the magnet bonding portion in order to increase a bonding force with the adhesive. A method for providing irregularity thereon can be that for performing chemical-etching on a surface which has been once surface-treated, with an acid or the like, in addition to mechanical methods such as a shotblasting-method and a method of transferring, at press-molding, irregularity on a surface of a mold. If irregularity is provided on the magnet bonding portion, the adhesive enters there, so that the bonding force with the magnet portion 25 is strengthen due to an anchor effect. This is more preferable.

A bonding method using adhesive is most suitable for a method of bonding the magnet portion 25 and the core metal 15 to each other. Other bonding methods can be adapted to mechanically bond the magnet portion 25 and the core metal 15 to each other by performing swaging or providing a through hole or a cutout in a seal device body.

If the magnet portion 25 and the core metal 15 are bonded to each other simultaneously with molding thereof, it is necessary that adhesive used in bonding thereof is semicured at insert-molding thereof so as to be neither detached therefrom nor carried away therefrom by a molten high-pressure plastic magnet material and a fluidized rubber magnet material, and that the adhesive is completely cured due to heat from the molten resin and the fluidized rubber or by secondary heating after the molding, in addition thereto. In view of heat-resistance, chemical-resistance, and handling-ability, a phenolic-resin-based adhesive and an epoxy-resin-based adhesive, each of which can be diluted by a solvent and causes a curing reaction to proceed substantially in two stages, are desirable as an available adhesive. The type of an adhesive preferably used in forming the magnet portion as a separate body and adhesively bonding the magnet portion to the seal device body is not limited to a specific type, as long as the magnet portion can adhesively be bonded to the seal device body. However, in view of beat-resistance and water-resistance, a one-component epoxy-resin-based adhesive is most suitable therefor. It is not always necessary to limit the adhesive to a specific one that can be diluted by a solvent, as described above. In addition, a two-component epoxy-resin-based adhesive curable at room temperature, and a UV-cured acrylic adhesive curable by UV can be used.

If the magnet material is a plastic magnet using thermoplastics as binder, a method of molding the magnet portion by magnetic field injection molding of a disc gate type that doesn't generate a welded portion at which mechanical strength is reduced, or of a ring gate type similar to the disc gate type is most suitable for a method of molding the magnet portion 25, from the viewpoint of the magnetic characteristic. This method of molding the magnet portion can be applied to the rolling bearing, if the magnet portion is adhesively bonded to the seal device body after the injection molding thereof. However, in the case of performing insert-molding using the seal device body as a core, it is impossible from the viewpoint of a mold structure to apply the above method of molding the magnet portion to the rolling bearing. In this case, a method of performing magnetic field injection molding of a pin gate type, in which gates such as pin gates are provided at portions other than a magnet detection portion is employed. In the case of using such pin gates, there is a risk that a gate trace protrudes and affects adversely the detection. Thus, it is more preferable that each portion having the gate is shaped so as to be slightly thinner than the detection portion and as to prevent interference with the magnetic sensor 29.

In the case of using a rubber magnet as the magnet material, if the molding of the magnet portion 25 is performed by injection-molding, it is preferable to perform the injection-molding of the disc gate type, similarly to the case of using the plastic magnet as the magnet material. However, if vulcanization adhesion is performed simultaneously with the molding, the injection-molding of the pin gate type is performed, similarly to the above case. If the molding of the magnet portion is performed by compression-molding, the molding thereof is performed by carrying out vulcanization adhesion in a state in which the seal device body is provided in the mold (female mold), while covering the seal device body with a sheet-like unvulcanized rubber magnet.

Incidentally, after demagnetized, the magnet portion 25 is magnetized multipolarly and circumferentially. The number of poles ranges 2 to 100 or so and is determined according to the usage of the bearing. If the number of poles ranges 2 to 20 or so and is relatively small, magnetization using general magnetizing yokes can be performed. If the number of poles ranges 20 to 100 or so and is large, each pole width is reduced to be small. Thus, it is difficult to process the magnetizing yokes. In this case, magnetization according to a rotational magnetization method for magnetizing parts of the magnet portion 25 into 1 to 3 poles at a time is suitable.

In addition, a nitrile rubber-based material is suitable for the elastic material used in forming the fitting portions 30 and 36 and the seal lip portions 31 and 37 in the magnet-portion-side seal device 23 and the other seal device 16 and in covering the core metal 35 in the other seal device 16. If heat-resistance is needed according to the usage environment, it is more preferable to change the elastic material to hydrogenated nitrile rubber, acrylic rubber, fluororubber, silicon rubber, or the like. Such elastic materials are bonded by vulcanization adhesion to the core metals 15, 35.

In the above bearing, the inner ring 12 is used as a rotating ring. The magnet-portion-side seal device 23 is fixed by providing the fitting groove 17. However, the bearing can be set to be of an outer-ring rotation type, in which the outer ring 11 is used as a rotating ring and in which the magnet-portion-side seal device is fixed by providing similar fitting grooves. In this case, the fitting portions of the seal devices are formed at the outside-diameter-side, while the seal lip portions are formed at the inside-diameter-side.

### EXAMPLES

Hereinafter, the invention is further described by citing an example. However, the invention is not limited thereto.

A rolling bearing illustrated in FIG. 1 was manufactured. First, a phenolic-resin-based adhesive (METALOC N-15 by TOYOKAGAKU KENKYUSHO Co., LTD) which included 30% of a solid content whose main component was a novolac-type phenolic resin and which was diluted by three times with methyl ethyl ketone was applied with a brush to vicinity of an inner peripheral portion of each core metal (made of an electrogalvanized steel whose topmost layer was phosphatized) having a flange portion to be fit. Then, the core metals were dried 30 minutes at room temperature. After that, the core metals were left in a drier at 120° C. for 30 minutes. Thus, the core metals were brought into a semicured state. Then, fitting portions and seal lip portions, each of which was made of nitrile rubber, were bonded to the core metals by vulcanization adhesion.

Next, an adhesive-agent similar to the above adhesive was applied to a magnet-portion bonding surface of each core metal provided with the fitting portion and the seal lip portion. Then, the core metals were put into a semicured state and left in a mold. Next, a plastic magnet material whose composition is shown in Table 1 listed below was subjected to injection-molding (insert-molding). Thus, a magnet portion was bonded to the core metal. When the injection-molding was performed, magnetic field injection molding for applying a magnetic field axially was conducted. After demagnetized so that the magnetic flux density was equal to or less than 2 mT, the magnet portion was magnetized with the magnetizing yokes into 16 poles such that an N-pole and an S-pole are alternately arranged. Then, after reduction of magnetism, the core metal and the like were heated at 150° C. for 1 hour in order to completely cure the adhesive. Incidentally, 4-point pin gates were formed as gates for injection-molding on a thin part other than the detection portion to be circumferentially equally spaced. Thus, the magnet-portion-side seal device was manufactured.

A bending deflection amount of the above magnet portion was measured. In addition, an operation of retaining the above magnet portion at 120° C. for 30 minutes, and an operation of retaining the above magnet portion at −40° C. for 30 minutes were performed repeatedly. Table 1 shows results.

Regarding the other seal device, similarly, the fitting portion and the seal lip portion are provided on the core metal. In addition, the core metal was manufactured by being covered with nitrile rubber.

Then, the above seal devices were mounted on a seal-equipped single-row deep groove ball bearing (“6005” manufactured by Nippon Seiko Corporation). A magnetic sensor with a gap of 1 mm was mounted thereon to be opposed to the magnet portion of the magnet-portion-side seal device. Then, signal validation was performed. Consequently, it was confirmed that there was no problem in the detection of the number of revolutions.

In addition, 30% of an inner space was filled with grease in the bearing. A grease leakage test was performed (i.e., the bearing was rotated at 100° C. at 1000 rpm, and a leakage weight was measured before or after the rotation of the bearing). Thus, it was found that a grease leakage amount was reduced to about 20%, as compared with the case of using the magnet-portion-side seal device having a shape illustrated in FIG. 3.

TABLE 1

| | Example 1 | Example 2 |
|---|---|---|
| Sr Ferrite (wt %) | 89.5 | 30.6 |
| Sm₂Co₁₇ (wt %) | 0 | 56.9 |
| PA12 (wt %) | 7.0 | 8.4 |
| Modified PA12 (wt %) | 3.0 | 3.6 |
| Silane Coupling Agent (wt %) | 0.3 | 0.3 |
| Amine-based Antioxidant (wt %) | 0.2 | 0.2 |
| Bending Deflection Amount (ASTM | 5.6 | 4.0 |
| D790, t = 3.2, Room Temperature) | | |
| BHmax [kJ/m³] (MGOe) | 14.3 (1.8) | 27.9 (3.5) |
| [at Magnetic Field Molding] | | |
| Results of Thermal Shock Test | No Crack | No Crack |
| (120° C. 30 min [symbol] −40° C. 30 min) | Generated at | Generated at |
| | 1000 Cycles | 1000 Cycles |

Sr Ferrite: Anisotropic Sr Ferrite for Magnetic Field Orientation, FERO TOP FM-201 [Manufactured by Toda Kogyo Corporation]

Sm₂Co₁₇: Sm₂Co₁₇ XG28/20 (CHENGDU MAGNETIC MATERIAL SCIENCE AND TECHNOLOGY Co., Ltd.)

PA12: PA12 Powder P3012U (Containing Hindered Phenol-eased Antioxidant, Manufactured by Ube Industries, Ltd.)

Modified PA12: UBEPAE 1210U (Containing Hindered Phenol-Based Antioxidant, Manufactured by Ube Industries, Ltd.)

Silane Coupling Agent: γ-aminopropyltriethoxysilane, 1100 (Manufactured by Nippon Unicar Co., Ltd.)

Amine-based Antioxidant: N, N′-diphenyl-p-phenylenediamine Nocrack DP (Manufactured by Ouchi Shinko Chemical Industrial Co., Ltd.)

Although description has been made with reference to specific embodiments of the invention, it will be obvious to those skilled in the art that various changes and modification can be made therein without departing from the spirit and scope of the invention.

The present application is based on Japanese Patent Application No. 2010-100906 filed on Apr. 26, 2010, and the contents thereof are incorporated herein by reference.

### INDUSTRIAL APPLICABILITY

The invention is useful in detecting the number of revolutions of a rolling bearing for use in a washing machine, a motorcycle, or the like.

### DESCRIPTION OF REFERENCE NUMERALS AND SIGNS

11 outer ring

12 inner ring

13 ball

16 other seal device

23 magnet-portion-side seal device

25 magnet portion

29 magnetic sensor

1. A rolling bearing comprising: a stationary ring; a rotating ring; a plurality of rolling elements provided circumferentially rotatably in an annular space defined by the stationary ring and the rotating ring; a retainer configured to retain the rolling elements rotatably; and a pair of seal devices configured to seal an opening end portion of the annular space, the rolling bearing, wherein:
fitting grooves of the rotating ring for mounting the seal devices are respectively formed on both end surfaces of the rotating ring into shapes symmetrical about the rolling element, that seal grooves of the stationary ring are respectively formed on both end surfaces of the stationary ring into shapes symmetrical about the rolling element; and
each of the pair of seal devices is configured by connecting a fitting portion made of an elastic material to be fit to the fitting groove to an end portion of each core metal, and by connecting a seal lip portion made of an elastic material to be brought into sliding contact with the seal groove to the other end portion of the one of the core metals, the pair of seal devices are respectively formed into shapes symmetrical about the rolling element, and a magnet portion facing a magnetic sensor of a magnetic encoder is bonded to one of the core metals, while the other core metal is covered with the elastic material.

2. The rolling bearing according to claim 1, wherein
the magnet portion protrudes from an axial end surface of each of the stationary ring and the rotating ring.

3. The rolling bearing according to claim 1, wherein
the magnet portion includes magnetic material powder and a thermoplastic resin.

4. The rolling bearing according to claim 3, wherein
the thermoplastic resin is at least one resin selected from the group consisting of polyamide 6, polyamide 66, polyamide 12, polyamide 612, polyamide 610, polyamide 11, polyphenylene sulfide (PPS), modified polyamide 6T, polyamide 9T, modified polyamide 12 that has a molecular structure including a soft segment, a modified polyester resin that has a molecular structure including a soft segment, and a modified polystyrene resin that has a molecular structure including a soft segment.

5. The rolling bearing according to claim 1, wherein
the magnet portion includes magnetic material powder and rubber.

6. The rolling bearing according to claim 5, wherein
the rubber is at least one type of rubber selected from the group consisting of nitrile rubber, acrylic rubber, fluororubber, and silicon rubber.

7. The rolling bearing according claim 1, wherein
the magnet portion is bonded thereto by insert-molding using, as a core, the core metal coated with a semicured adhesive, and the adhesive is a phenolic resin-based adhesive or an epoxy resin-based adhesive, whose curing reaction proceeds in two stages.

8. The rolling bearing according to claim 1, wherein
the magnet portion is bonded to the core metal with an adhesive, and the adhesive is at least one type of an adhesive selected from the group consisting of one-component epoxy resin-based adhesive, a two-component epoxy resin-based adhesive, and an ultraviolet (UV) cured acrylic adhesive.
